(19) United States
(12) Patent Application Publication
(10) Pub. No.: US 2006/0251465 A1
(43) Pub. Date: Nov. 9, 2006

(54) De-icing scrapers

(76) Inventors: Michael Savoia SR., Bensenville, IL (US); Michael Savoia JR., Bensenville, IL (US)

Correspondence Address: Donald J. Ersler, 725 Garvens Avenue, Brookfield, WI, 53005, US

(21) Appl. No.: 11/120,552

(22) Filed: May 3, 2005

(51) Int. Cl. B05C 11/00; B43K 1/06

(52) U.S. Cl. 401/266; 401/265

(57) ABSTRACT

A de-icing scraper preferably includes a scraper member, a handle member, a trigger device and a pressurized de-icing cartridge. The pressurized de-icing cartridge is retained in the scraper member. The trigger device is used to push the pressurized de-icing cartridge to release de-icer fluid therefrom. The de-icer fluid is dispensed through at least one spray tunnel adjacent the scrapper member. A second embodiment of the de-icing scraper includes a scraper member, a handle member and a fluid pump. De-icing fluid is retained in the scraper member and the fluid pump is retained in the handle portion. The fluid pump is actuated to dispense de-icing fluid through at least one spray tunnel adjacent the scraper member. A third embodiment of the de-icing scraper includes a scraper member, a handle member, a fluid pump and a de-icer container.

### BACKGROUND OF THE INVENTION

1. Field of the Invention

The present invention relates generally to the removal of ice from a vehicle windshield and more specifically to de-icing scrapers, which not only scrape ice, but dispense a de-icing fluid on to an ice covered windshield.

2. Discussion of the Prior Art

There are numerous ice scrappers in the art. One example of an ice scrapper with a de-icing dispenser is U.S. Pat. No. 6,283,656 to Jiang, entitled handheld windshield de-icer. The Jiang patent includes a hand operated de-icer for cleaning ice and snow from a windshield of a vehicle including a sprayer that forces an antifreeze liquid from its bottle through a heated nozzle onto the windshield. However, the user must connect the handheld windshield de-icer to a cigarette lighter of a vehicle, which makes its use and maneuverability difficult.

Accordingly, there is a clearly felt need in the art for de-icing scrappers, which not only scrape ice, but dispense a de-icing fluid on to an ice covered windshield to decrease the amount time and labor required to remove the ice.

### SUMMARY OF THE INVENTION

The present invention provides de-icing scrapers, which scrap ice and dispense a de-icing liquid. A de-icing scraper preferably includes a scraper member, a handle member, a trigger device and a pressurized de-icing cartridge. The scraper member includes a scraper portion and a handle portion that extends from the scraper portion. An end of the handle portion preferably includes a threaded end. A handle bore is formed through the handle portion to receive the pressurized de-icing cartridge. A raised area is formed at substantially the junction of the scraper portion and the handle portion. At least one spray tunnel is formed from the pressurized de-icing cartridge through the raised area.

An internal thread is formed in one end of the handle member to threadably receive the threaded end. The trigger device includes a finger trigger and a cartridge pusher that is pivotally retained by one end of the finger trigger. The trigger device is inserted through a slot in the handle member. The finger trigger is pivotally retained by inserting a pin through thereof and the handle member. Pulling the trigger causes the pressurized de-icing cartridge to move forward and release the de-icing fluid.

A second embodiment of the de-icing scraper preferably includes a scraper member, a handle member and a fluid pump. The scraper member includes a scraper portion and a handle portion that extends from the scraper portion. A handle bore is formed through the handle portion to receive de-icing fluid. An insert counterbore is formed in an end of the handle bore. A threaded boss extends from a perimeter of the handle portion. A fill opening is formed through the threaded boss. The threaded bore sized to receive a threaded cap. A raised area is formed at substantially the junction of the scraper portion and the handle portion. At least one spray tunnel is formed from the raised area.

A reduced diameter is formed on one end of the handle member. The reduced diameter is sized to be inserted into the insert counterbore. The fluid pump includes a pump member, a push rod and a finger trigger. The pump member is preferably retained in the one end of the handle member. The push rod extends from the pump member and one end of the finger trigger is pivotally retained thereby. The finger trigger is inserted through a slot in the handle member. The finger trigger is pivotally retained by inserting a pin through thereof and the handle member. One end of an output fluid line is connected to an output port of the fluid pump and the other end is connected to one end of the spray tunnel. The handle member is filled with de-icing fluid through the fill opening. Pulling the trigger causes the de-icing fluid to be drawn by the fluid pump and expelled from the at least spray tunnel through the output fluid line.

A third embodiment of the de-icing scraper includes a scraper member, a handle member, a fluid pump and a de-icer container. The scraper member includes a scraper portion, a handle portion and a container sleeve. The handle portion extends from the scraper portion. The container sleeve is preferably formed around one end of the handle portion. An inner perimeter of the container sleeve is sized to receive an open end of the de-icer container. A handle bore is formed through the handle portion to provide clearance for at least one fluid line. An insert counterbore is formed in the other end of the handle portion. A raised area is formed at substantially the junction of the scraper portion and the handle portion. At least one spray tunnel is formed through the raised area.

A reduced diameter is formed on one end of the handle member. The reduced diameter is sized to be inserted into the insert counterbore. The fluid pump includes a pump member, a push rod and a finger trigger. The pump member is preferably retained in the one end of the handle member. The push rod extends from the pump member and one end of the finger trigger is pivotally retained thereby. The trigger device is inserted through a slot in the handle member. The finger trigger is pivotally retained by inserting a pin through thereof and the handle member. One end of an output fluid line is connected to an output port of the fluid pump and the other end is connected to one end of the spray tunnel. At least one container fluid line is retained in the de-icer container to draw de-icing fluid from inside thereof. The de-icer container is filled with de-icing fluid and inserted into the container sleeve. Pulling the trigger causes the de-icing fluid to be drawn by the fluid pump and expelled from the at least spray tunnel through the output fluid line.

A dovetail slot is preferably formed in the scraper member, adjacent the scraper edge in the first second or third embodiments of the de-icing scraper. The dovetail slot is sized to receive one end of the squeegee blade. A brush may also be attached to the other end of the handle member.

Accordingly, it is an object of the present invention to provide a de-icing scraper, which includes a pressurized cartridge for dispensing de-icer fluid on to an ice covered windshield to decrease the amount time and labor required to remove the ice.

It is a further object of the present invention to provide a de-icing scraper, which retains de-icer fluid in a handle for application to an ice covered windshield to decrease the amount time and labor required to remove the ice.

Finally, it is another object of the present invention to provide a de-icing scraper, which retains de-icer fluid in a container for application to an ice covered windshield to decrease the amount time and effort required to remove the ice.

These and additional objects, advantages, features and benefits of the present invention will become apparent from the following specification.

### BRIEF DESCRIPTION OF THE DRAWINGS

FIG. 1 is a perspective view of a de-icing scraper in accordance with the present invention.

FIG. 1a is a perspective view of a de-icing scraper with a squeegee blade retained thereby in accordance with the present invention.

FIG. 1b is a cross-sectional view of a scraper portion of a de-icing scraper with a squeegee blade retained thereby in accordance with the present invention.

FIG. 2 is a perspective view of a partial handle portion separated from a partial handle member of a de-icing scraper in accordance with the present invention.

FIG. 3 is a cross-sectional view of a de-icing scraper cut through FIG. 1 in accordance with the present invention.

FIG. 4 is a perspective view of a second embodiment of a de-icing scraper in accordance with the present invention.

FIG. 5 is a perspective view of a partial handle portion separated from a partial handle member of a second embodiment of a de-icing scraper in accordance with the present invention.

FIG. 6 is a cross-sectional view of a second embodiment of a de-icing scraper cut through FIG. 4 in accordance with the present invention.

FIG. 7 is a perspective view of a third embodiment of a de-icing scraper in accordance with the present invention.

FIG. 8 is a perspective view of a partial handle portion separated from a partial handle member of a third embodiment of a de-icing scraper in accordance with the present invention.

FIG. 9 is a cross-sectional view of a third embodiment of a de-icing scraper cut through FIG. 7 in accordance with the present invention.

### DETAILED DESCRIPTION OF THE PREFERRED EMBODIMENTS

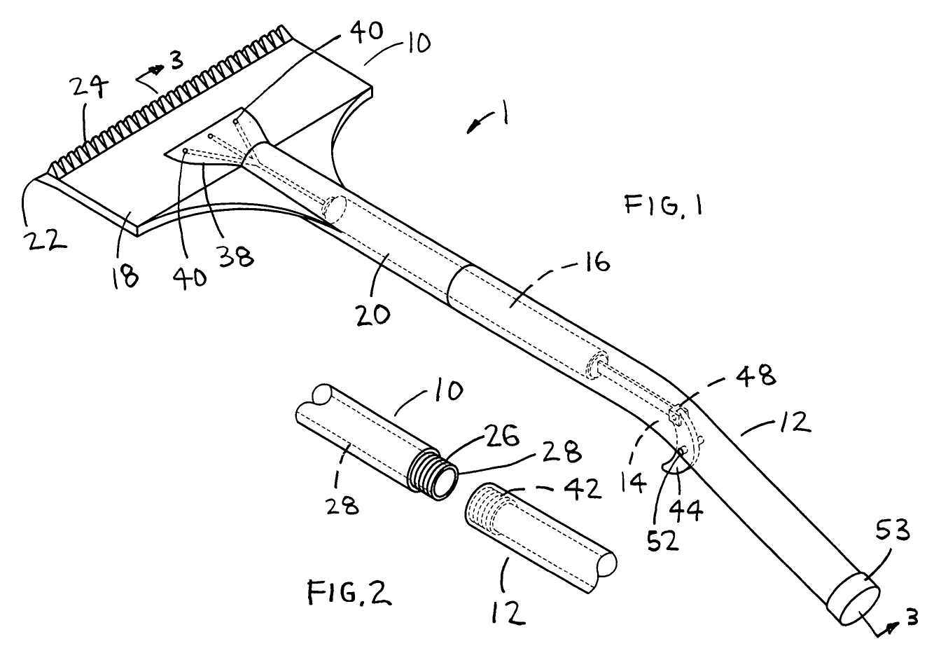

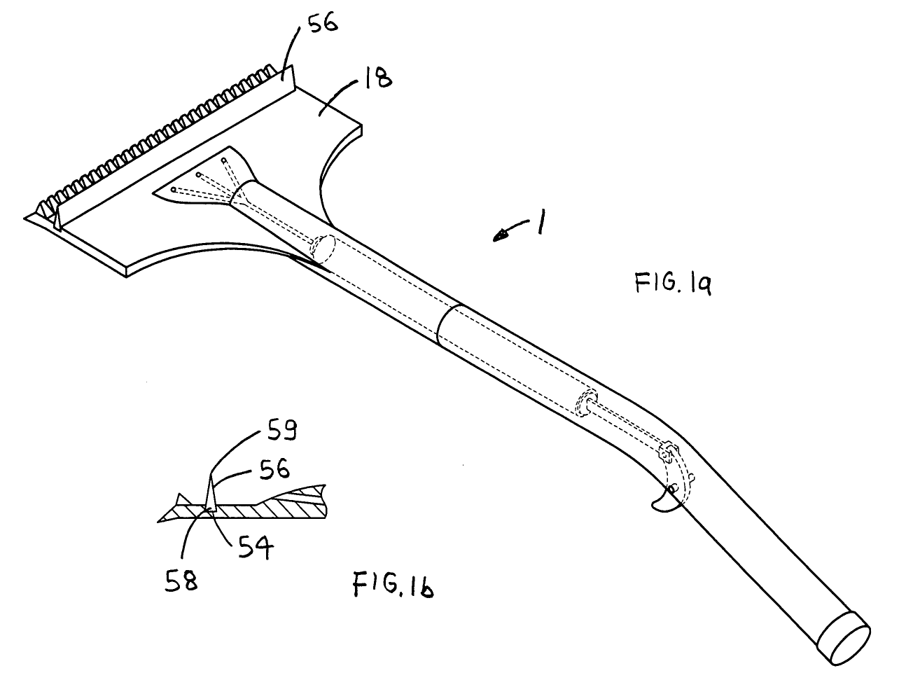

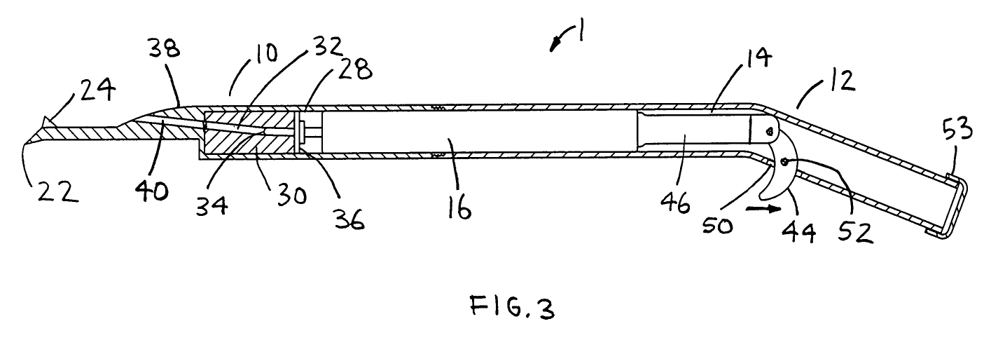

With reference now to the drawings, and particularly to FIG. 1, there is shown a perspective view of a de-icing scraper 1. With reference to FIGS. 2-3, the de-icing scraper 1 preferably includes a scraper member 10, a handle member 12, a trigger device 14 and a pressurized de-icing cartridge 16. The scraper member 10 includes a scraper portion 18 and a handle portion 20. The scraper portion 18 is terminated with a scraping edge 22 on one end and a plurality of scraping projections 24 are preferably formed adjacent the scraping edge 22. One end of the handle portion 20 extends from the other end of the scraping portion 18. A thread end 26 is preferably formed on the other end of the handle portion 20. A handle bore 28 is formed through the handle portion 20 to receive the pressurized de-icing cartridge 16. A fluid plug 30 is preferably inserted into a bottom of the handle bore 28. The fluid plug 30 includes a fluid passage 32.

The pressurized de-icing cartridge 16 is filled with a de-icing fluid. Pressurized cartridges are well known in the art for cleaning applications and do not require a detailed explanation. A release nozzle 34 extends from one end of the pressurized de-icing cartridge 16. A push plate 36 is secured to the release nozzle 34. The fluid passage 32 is sized to receive the release nozzle 34. A raised area 38 is formed at substantially the junction of the scraper portion 18 and the handle portion 20. At least one spray tunnel 40 is formed from one end of the handle bore 28 through the raised area 38. The fluid passage 32 communicates with the at least one spray tunnel 40, such that de-icing fluid flows from the release nozzle 34 through the fluid passage 32 and the at least one spray tunnel 40.

An internal thread 42 is formed in one end of the handle member 12 to threadably receive the threaded end 26. The trigger device 14 includes a finger trigger 44 and a cartridge pusher 46. A yoke 48 is formed on end of the cartridge pusher 46. The yoke 48 is sized to receive one end of the finger trigger 44. The one end of the finger trigger 44 is pivotally retained in the yoke 48. The trigger device 14 is inserted through a trigger slot 50 formed through a tubular cross section of the handle member 12. The finger trigger 44 is pivotally retained in the handle member 12 by inserting a pin 52 through thereof and the handle member 12. Pulling the finger trigger 44 back (as shown by the direction of the arrow) causes the pressurized de-icing cartridge 16 to move forward. The forward motion causes the release nozzle 34 to be pushed back into the pressurized de-icing cartridge 16, which breaks a seal that releases the de-icing fluid. The other end of the handle portion 12 is preferably terminated with an end cap 53.

With reference to FIGS. 1a-1b, a female dovetail slot 54 is formed in the scraper member 10, adjacent the scraper projections 24. A male dovetail 58 is formed on one end the squeegee blade 56 and a squeegee edge 59 is formed on the other end thereof. The female dovetail slot 54 is sized to receive the male dovetail 58. The squeegee blade 56 is also designed to be retained in the scraper members 60, 110 of the de-icing scrapers 2, 3.

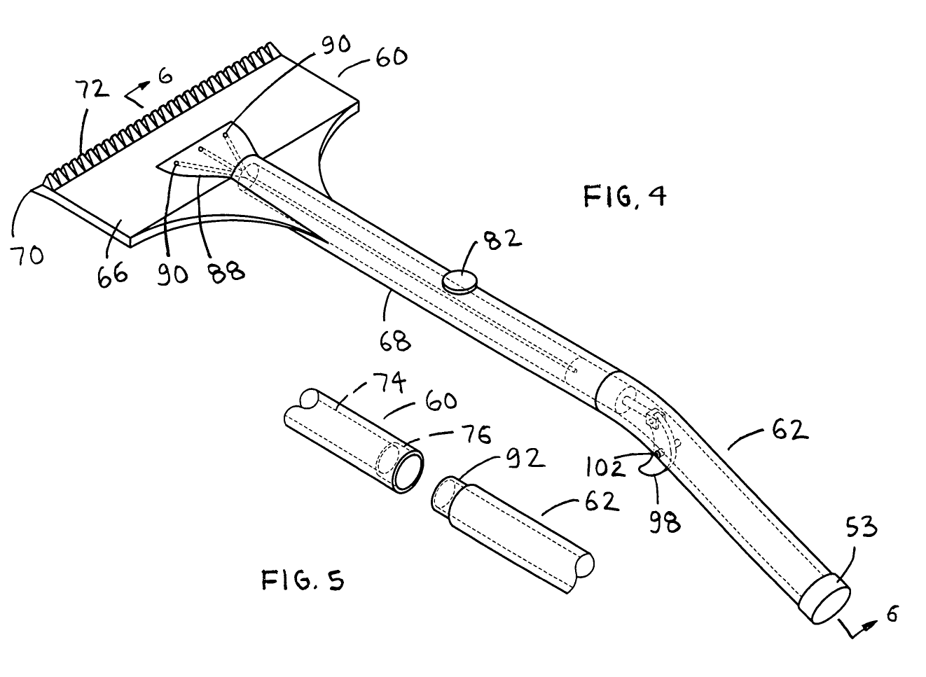

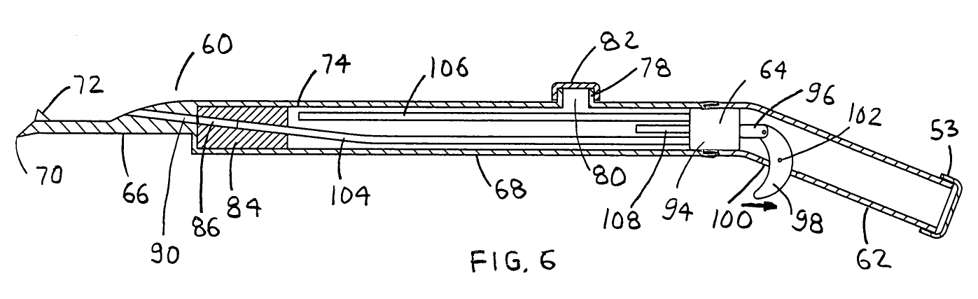

With reference to FIGS. 4-6, a second embodiment of the de-icing scraper 2 includes a scraper member 60, a handle member 62 and a fluid pump 64. The scraper member 60 includes a scraper portion 66 and a handle portion 68. The scraper portion 66 is terminated with a scraping edge 70 on one end and a plurality of scraping projections 72 are preferably formed adjacent the scraping edge 70. One end of the handle portion 68 extends from the other end of the scraping portion 66. A handle bore 74 is formed through the handle portion 68 to receive de-icing fluid. An insert counterbore 76 is formed in the other end of the handle portion 68 A threaded boss 78 extends from a perimeter of the handle portion 68. A fill opening 80 is formed through the threaded boss 78. The threaded bore 78 sized to receive a threaded cap 82. However, other methods of filling the handle portion 68 with de-icing fluid may also be used.

A fluid plug 84 is inserted to a bottom of the handle bore 74. The fluid plug 84 includes a fluid passage 86. A raised area 88 is formed at substantially the junction of the scraper portion 66 and the handle portion 68. At least one spray tunnel 90 is formed from one end of the handle bore 74 through the raised area 88. The fluid passage 86 communicates with the at least one spray tunnel 90, such that de-icing fluid flows through the fluid passage 86 and the at least one spray tunnel 90.

A reduced diameter 92 is formed on one end of the handle member 62. The reduced diameter 92 is sized to be inserted into the insert counterbore 76. The scraper member 60 is rigidly retained relative to the handle member 62 by securing the reduced diameter 92 in the insert counter 76 with an adhesive, glue, sonic welding, staking or any other suitable process. The fluid pump 64 includes a pump member 94, a push rod 96 and a finger trigger 98. The pump member 94 is similar to a manual pump on a water squirt gun. Manual pumps are well known in the art and need not be explained in detail. The pump member 94 is preferably retained in the one end of the handle member 62 with any suitable method. The push rod 96 extends from the pump member 94 and one end of the finger trigger 98 is pivotally retained thereby. The finger trigger 98 is inserted through a slot 100 in the handle member 62. The finger trigger 98 is pivotally retained by inserting a pin 102 through thereof and the handle member 62.

One end of an output fluid line 104 is connected to an output port of the fluid pump 64 and the other end is retained in the fluid passage 86. A first input fluid line 106 is attached to a first input port of the fluid pump 64. The first input fluid line 106 extends, such that thereof is adjacent to the fluid plug 84. A second input fluid line 106 is attached to a second input port of the fluid pump 64. The second input fluid line 108 only extends a short distance past the fluid pump 64. The first and second input ports may be connected to each other inside or outside the fluid pump 64. The handle bore 74 is filled with de-icing fluid through the fill opening 80. Pulling the finger trigger 98 back (as shown by the direction of the arrow) causes a vacuum to be placed on the ends of the first and second input fluid lines. The de-icing fluid is pulled through the first or second fluid lines and expelled through the output fluid line 104, the fluid passage 86 and the at least one spray tunnel 90. The other end of the handle portion 62 is preferably terminated with an end cap 53.

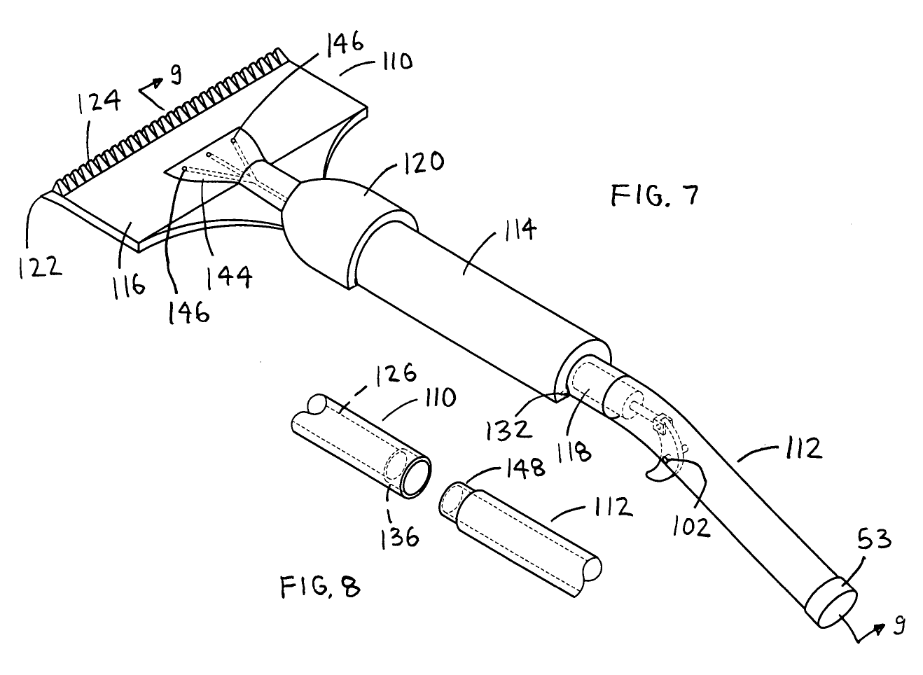

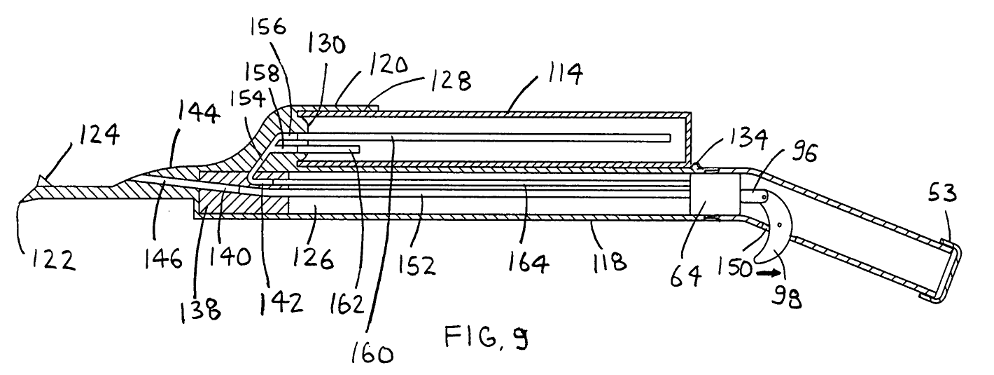

With reference to FIGS. 7-9, a third embodiment of the de-icing scraper 3 preferably includes a scraper member 110, a handle member 112, a fluid pump 64 and a de-icer container 114. The scraper member 110 includes a scraper portion 116, a handle portion 118 and a container sleeve 120. The scraper portion 116 is terminated with a scraping edge 122 on one end and a plurality of scraping projections 124 are preferably formed adjacent the scraping edge 122. One end of the handle portion 118 extends from the other end of the scraping portion 116. A handle bore 126 is formed through the handle portion 118 to provide clearance for at least one fluid line.

The container sleeve 120 includes an inner perimeter 128 and a perimeter projection 130. The inner perimeter 128 is sized to receive an outer perimeter of the de-icer container 114. The perimeter projection 130 is sized to receive an inner perimeter of the de-icer container 114. The de-icer container 114 preferably has a substantially tubular U-shaped cross section, but other shapes may also be used. A bottom of the de-icer container 114 preferably has a snap-over lip 132 to radially retain the de-icer container 114 relative to the handle portion 118. At least one retention projection 134 preferably extends from an outer perimeter of the handle portion 118 to axially retain the de-icer container 114 relative to the handle portion 118. An insert counterbore 136 is formed in the other end of the handle portion 118.

A fluid plug 138 is inserted to a bottom of the handle bore 126. The fluid plug 138 includes a first fluid passage 140 and a second fluid passage 142. A raised area 144 is formed at substantially the junction of the scraper portion 116 and the handle portion 118. At least one spray tunnel 146 is formed from one end of the handle bore 126 through the raised area 140. The fluid passage 140 communicates with the at least one spray tunnel 146, such that de-icing fluid flows through the fluid passage 140 and the at least one spray tunnel 146. A reduced diameter 148 is formed on one end of the handle member 112. The reduced diameter 148 is sized to be inserted into the insert counterbore 136. The scraper member 110 is rigidly retained relative to the handle member 112 by securing the reduced diameter 148 in the insert counter 136 with an adhesive, glue, sonic welding, staking or any other suitable process.

The pump member 94 is preferably retained in the one end of the handle member 112 with any suitable method. The finger trigger 98 is inserted through a slot 150 in the handle member 112. The finger trigger 98 is pivotally retained by inserting a pin 102 through thereof and the handle member 112. One end of an output fluid line 152 is connected to an output port of the fluid pump 64 and the other end is retained in the fluid passage 140. A container flow passage 154 is formed substantially through the container sleeve 120. A first container input passage 156 and a second container input passage 158 are formed in the perimeter projection 130 and communicate with the container flow passage 154. A first input fluid line 160 is retained in the first container input passage 156. The first input fluid line 160 extends to the other end of the de-icer container 114. The second input fluid line 162 is retained in the second container input passage 158.

One end of a master input fluid line 164 is retained in the second fluid passage 142 and the other end is attached to an input port of the fluid pump 64. The de-icer container 114 is filled with de-icing fluid and inserted into the container sleeve 120. Pulling the finger trigger 98 back (as shown by the direction of the arrow) causes a vacuum to be placed on the ends of the first and second input fluid lines through the master input fluid line 164. The de-icing fluid is pulled through the master input fluid line 164 and expelled through the output fluid line 152, the fluid passage 140 and the at least one spray tunnel 146. The other end of the handle portion 112 is preferably terminated with an end cap 53. A brush may be attached to the other end of the handle member 12, 62, 112.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A method of scraping ice from a windshield utilizing de-icing fluid, comprising the steps of:
providing a scraper member having a scraping portion and a handle portion extending from said scraping portion;
retaining pressurized de-icing fluid in said handle portion;
forming at least one spray tunnel in said scraper member;
releasing said pressurized de-icing fluid from said handle member through said at least one spray tunnel.

2. The method of scraping ice from a windshield utilizing de-icing fluid of claim 1, further comprising the step of:
attaching removably a handle member to said handle portion.

3. The method of scraping ice from a windshield utilizing de-icing fluid of claim 1, further comprising the step of:
retaining pressurized de-icing fluid in a pressurized de-icing cartridge, retaining said pressurized de-icing cartridge in said handle portion, said pressurized de-icing cartridge having a release nozzle.

4. The method of scraping ice from a windshield utilizing de-icing fluid of claim 3, further comprising the step of:
pivotally attaching a trigger device to said handle member, pulling said trigger to actuate said release nozzle to release de-icing fluid from said pressurized de-icing cartridge.

5. The method of scraping ice from a windshield utilizing de-icing fluid of claim 1, further comprising the step of:
forming a scraping edge on one of said scraping member.

6. The method of scraping ice from a windshield utilizing de-icing fluid of claim 1, further comprising the step of:
retaining a squeegee blade in said scraping member.

7. A method of scraping ice from a windshield utilizing de-icing fluid, comprising the steps of:
providing a scraper member having a scraping portion and a handle portion extending from said scraping portion;
forming at least one spray tunnel in said scraper member;
filling said handle portion with de-icing fluid;
providing a fluid pump having a trigger;
pulling said trigger to draw said de-icing fluid and to dispense said de-icing fluid through said at least one spray tunnel.

8. The method of scraping ice from a windshield utilizing de-icing fluid of claim 7, further comprising the step of:
attaching a handle member to said handle portion.

9. The method of scraping ice from a windshield utilizing de-icing fluid of claim 7, further comprising the step of:
forming a fill opening through said threaded boss, sealing said fill opening with a removable cap.

10. The method of scraping ice from a windshield utilizing de-icing fluid of claim 7, further comprising the step of:
forming a scraping edge on one of said scraping member.

11. The method of scraping ice from a windshield utilizing de-icing fluid of claim 7, further comprising the step of:
retaining a squeegee blade in said scraping member.

12. A method of scraping ice from a windshield utilizing de-icing fluid, comprising the steps of:
providing a scraper member having a scraping portion and a handle portion extending from said scraping portion;
forming at least one spray tunnel in said scraper member;
filing a de-icer container with de-icing fluid;
forming a container sleeve in said scraper member to receive an open portion of de-icer container;
providing a fluid pump having a trigger;
pulling said trigger to draw said de-icing fluid and to dispense said de-icing fluid through said at least one spray tunnel.

13. The method of scraping ice from a windshield utilizing de-icing fluid of claim 12, further comprising the step of:
attaching a handle member to said handle portion.

14. The method of scraping ice from a windshield utilizing de-icing fluid of claim 12, further comprising the step of:
providing said de-icer container with a substantially tubular U-shaped cross section.

15. The method of scraping ice from a windshield utilizing de-icing fluid of claim 12, further comprising the step of:
forming a scraping edge on one of said scraping member.

16. The method of scraping ice from a windshield utilizing de-icing fluid of claim 12, further comprising the step of:
retaining a squeegee blade in said scraping member.
